(19) United States
(12) Patent Application Publication
(10) Pub. No.: US 2003/0018883 A1
(43) Pub. Date: Jan. 23, 2003

(54) Microcode branch prediction indexing to macrocode instruction addresses

(76) Inventor: Stephan Jourdan, Portland, OR (US)

Correspondence Address: KENYON & KENYON, 1500 K STREET, N.W., SUITE 700, WASHINGTON, DC, 20005, US

(21) Appl. No.: 09/893,872

(22) Filed: Jun. 29, 2001

(51) Int. Cl. G06F 9/00

(52) U.S. Cl. 712/239

(57) ABSTRACT

A microcode branch predictor is presented. In an embodiment for a microcode branch predictor the microcode branch predictor includes a first input to accept macrocode instruction address data, a second input to accept microcode instruction address data, a processor to convert the macrocode instruction address data and microcode instruction address data to a value, an index to cross-reference the value to a microcode branch instruction result, and an output to signal whether the microcode branch instruction result is taken or not taken. In a method of generating an value to index a branch predictor, the method includes establishing a first pointer to a microcode address having a first pointer value, establishing a second pointer to a macrocode address having a second pointer value, hashing at least the first pointer value and the second pointer value to yield a hashing function value, and cross-referencing the hashing function value to a microcode branch result, wherein microcode branches are predicted based on the hashing function value.

### FIELD OF THE INVENTION

The invention relates to a method to index static and dynamic predictors for microcode branches.

### BACKGROUND

A program is a sequence of instructions that a processor executes. Each instruction has a specific address. Program flow in contemporary processors includes conditional branch instructions. A conditional branch instruction requires that the condition included within the instruction be evaluated in order to identify the next address to which program flow will continue. Rather than wait for the conditional branch instruction to be fetched, decoded, and executed before determining the next address to fetch, structures known as branch predictors are used to predict the next address. If the prediction proves to be correct, the processor is able to execute instructions following the branch without incurring unnecessary delay. If the branch prediction is incorrect, all instructions following the branch must be purged from execution and new instructions must be retrieved: this incurs several penalties for delay. Branch predictors predict whether the conditional branch will be taken based on branch algorithms that are well known in the art. Known branch predictor structures are indexed to the address of the macrocode instruction containing the conditional branch instruction.

Branch predictors are useful particularly when program flow returns to an instruction multiple times, such as may occur in a program loop. The processor's response in a previous iteration—the branch was taken or not taken—can be used as a basis on which to predict the processor's response to a branch in a current iteration. Typically, therefore, branch predictors may include history tables, which are indexed by the address of the branch instruction, that store information regarding the processor's historical response to the branch instruction.

Some instructions, not necessarily conditional branch instructions, are difficult to process. For this class of instruction, special subroutines are used to perform the functionality of the instruction in many small simple instructions, as compared to one complex instruction. The flow of instructions used to perform the functionality of a single instruction may be referred to as microcode.

Microcode program flow in current processors also may include conditional branch instructions. Conventional branch prediction techniques are applied to branch instructions in these microcode segments with mixed results. Because a particular microcode instruction, at a given microcode address, may be called by a plurality of macrocode instructions, conventional branch prediction techniques do not always result in accurate predictions. A history that is developed when the microcode instructions are called from a first macrocode instruction probably is not a useful basis on which to predict the processor's performance when the same microcode instructions are called by a second macrocode instruction.

Accordingly, there is a need in the art for a branch prediction method for a microcode instruction that distinguishes performance of a processor when the microcode instruction is called from various different macrocode instructions.

### BRIEF DESCRIPTION OF THE DRAWINGS

The various features of the invention will best be appreciated by simultaneous reference to the description which follows and the accompanying drawings, in which:

FIG. 1 illustrates a known branch predictor;

FIG. 2 is a block diagram of one embodiment of the invention;

FIG. 3 is block diagram of another embodiment of the invention; and

FIG. 4 represents the typical timing of instruction flow through a processor pipeline.

### DETAILED DESCRIPTION OF AN EMBODIMENT OF THE INVENTION

Embodiments of the present invention provide a branch predictor that indexes prediction tables by address information derived from a microcode instruction address and a macrocode instruction address. In this manner, for a particular microcode instruction the branch predictor may distinguish between different “contexts” of the microcode instruction—when called by a first macrocode instruction, the microcode history will be derived from a first location in the prediction tables and, when called by a second macrocode instruction, the microcode instruction's history will be derived from a second location in the prediction tables. Accuracy of a prediction may be improved because each branch may map to a unique counter; the mapping made possible by an index value that is at least a function of both the microcode branch instruction address and the macrocode instruction address that called the microcode branch instruction.

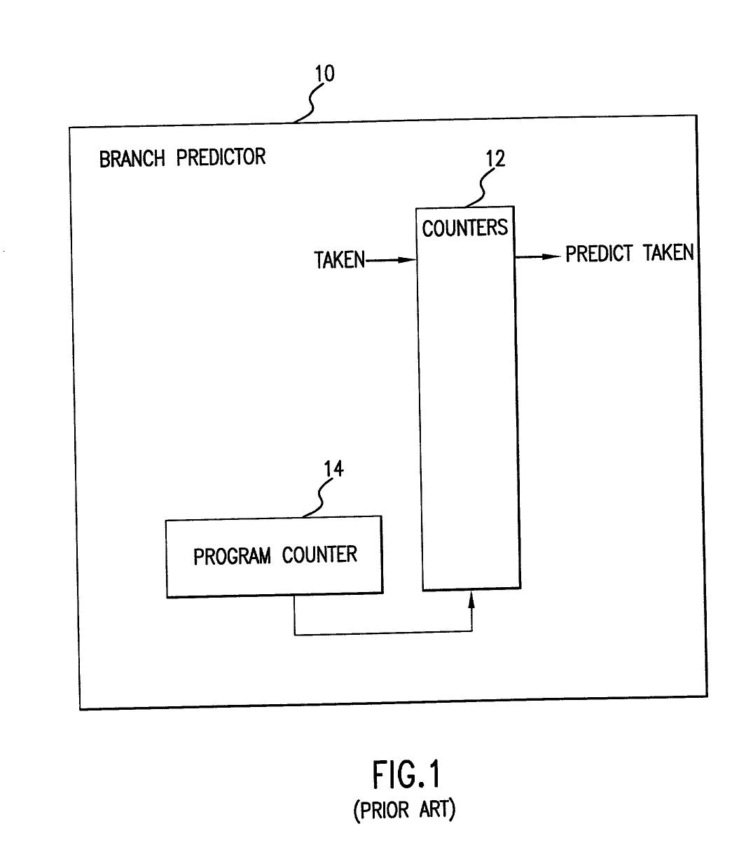

An example of a simple branch predictor 10 is illustrated in FIG. 1. FIG. 1 illustrates a history table 12, which is represented by a table of counters. The history table 12 may be indexed by, for example, the low order address bits in a program counter 14. The program counter 14 may store a macrocode address, which may be the instruction address currently in the fetch stage of a processor pipeline. The history table 12 may include 2ˆ N counters. Thus, the index to the history table is N bits. Each history table entry (i.e., each counter) may be two bits long. A state machine for this simple branch predictor may be represented as follows:

when predicting: if an entry is 0 or 1, then predict that the branch is not taken, but if the entry is 2 or 3, then predict that the branch is taken.

when updating the entry (once the branch has resolved): if the branch was taken, then increment the counter (saturate at 3), but if the branch was not taken, then decrement the counter (saturate at 0).

Thus, repeatedly taken branches will be predicted to be taken, and repeatedly not-taken branches will be predicted to be not taken. By using a two bit counter, the branch predictor 10 can tolerate a branch going in an unusual direction one time and yet still keep predicting the usual branch direction.

Another example of a more complex predictor may include use of the same structures as described in the examples above, but to index the history table with a function of both the macrocode address and the content of a shift register. The shift register may be identified as a branch history register. The function may be, for example, an exclusive or (XOR). The branch history register may record the outcome of the last predicted branches. One method of recording the outcome of the last predicted branches may be that upon each prediction the contents of the branch history register are shifted by one position and the new prediction is inserted. The encoding in the branch history register may be a zero (“0”) for a not taken prediction and a one (“1”) for a taken prediction.

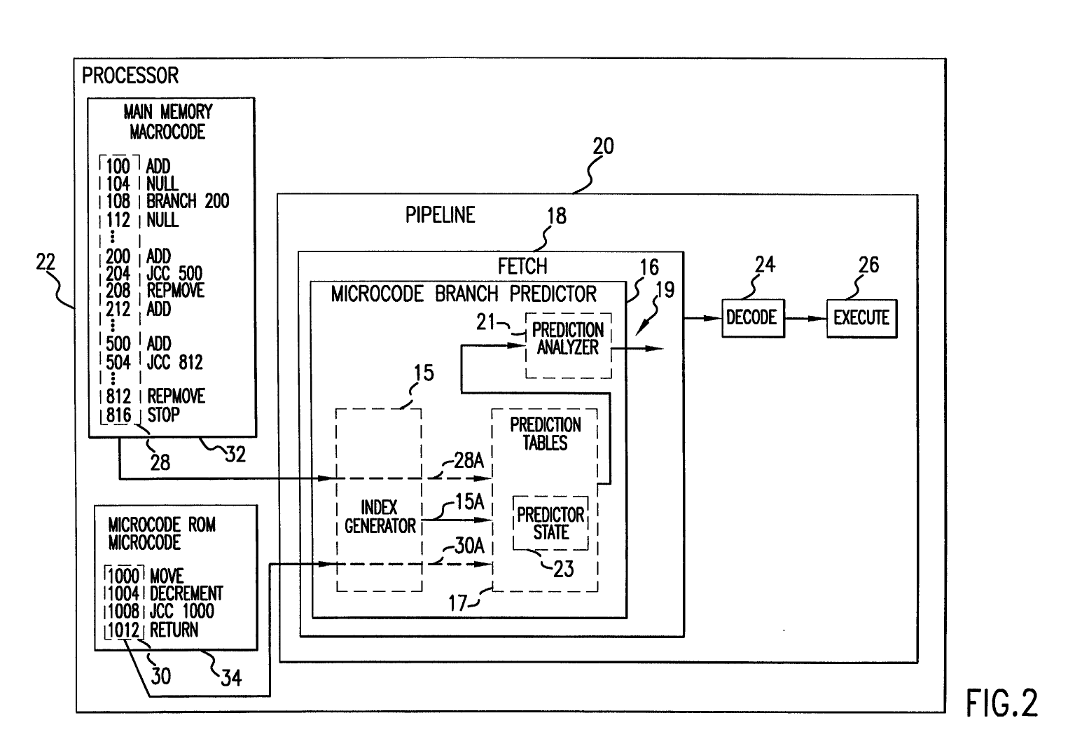

FIG. 2 is a block diagram of a processor 22 constructed in accordance with an embodiment of the present invention. The processor 22 includes a microcode branch predictor 16. The microcode branch predictor 16 may include prediction tables 17 to permit cross-referencing of addresses input to the microcode branch predictor to branch prediction results. Prediction tables 17 may also include predictor state 23, such as, for example, the branch history register as described in the example above. Prediction tables 17 may be comprised of several tables. The microcode branch predictor 16 may also include a prediction analyzer 21 to generate a prediction result based on data from the prediction tables 17. The functionality of the microcode branch predictor 16 may reside in a fetch stage 18 of a pipeline 20. Other stages in the pipeline 20 may include decode 24 and execute 26. Macrocode may reside in main memory 32, while microcode may reside in a microcode ROM 34.

The microcode branch predictor 16, in accordance with an embodiment of the invention, accepts a macrocode address 28 and a microcode address 30 as data inputs. A full address, or only a portion of the address, may be accepted without departing from the scope of the invention. Furthermore, a full address, or only a portion of the address may be used to generate an index value without departing from the scope of the invention. The index value may be generated in an index generator 15. While the index generator 15 is represented as being included within the microcode branch predictor 16, the index generator 15 may be located elsewhere without departing from the scope of the invention.

In a microcode branch predictor 16 in accordance with an embodiment of the invention, at least both macrocode addresses 28 and microcode addresses 30 may be used to index each microcode instruction for branch prediction. The microcode address 30 differentiates predictions among all microcode addresses for branch predictions. The macrocode address 28 differentiates predictions based on from where in the macrocode program the microcode instruction was called. The macrocode address 28 and the microcode address 30 may index the prediction tables directly, as illustrated by the dashed arrowheaded lines 28A and 30A, or the addresses 28, 30 may be applied to the index generator 15 to generate a single indexing value as represented by the solid arrowheaded line 15A. The microcode branch predictor 16 may be provided with an output 19 to signal whether the indexed value is representative of a branch being taken or not taken.

A mathematical function may be applied to the macrocode address 28 and the microcode address 30 within the functionality of the index generator 15. The mathematical function may be, for example, a hashing function. The mathematical function may generate a unique value for each combination of addresses. By using at least both the macrocode address and the microcode address to index a microcode branch predictor to render a prediction, different branches of the same microcode branch can be differentiated based on where the microcode is called from in the main program (the macrocode program).

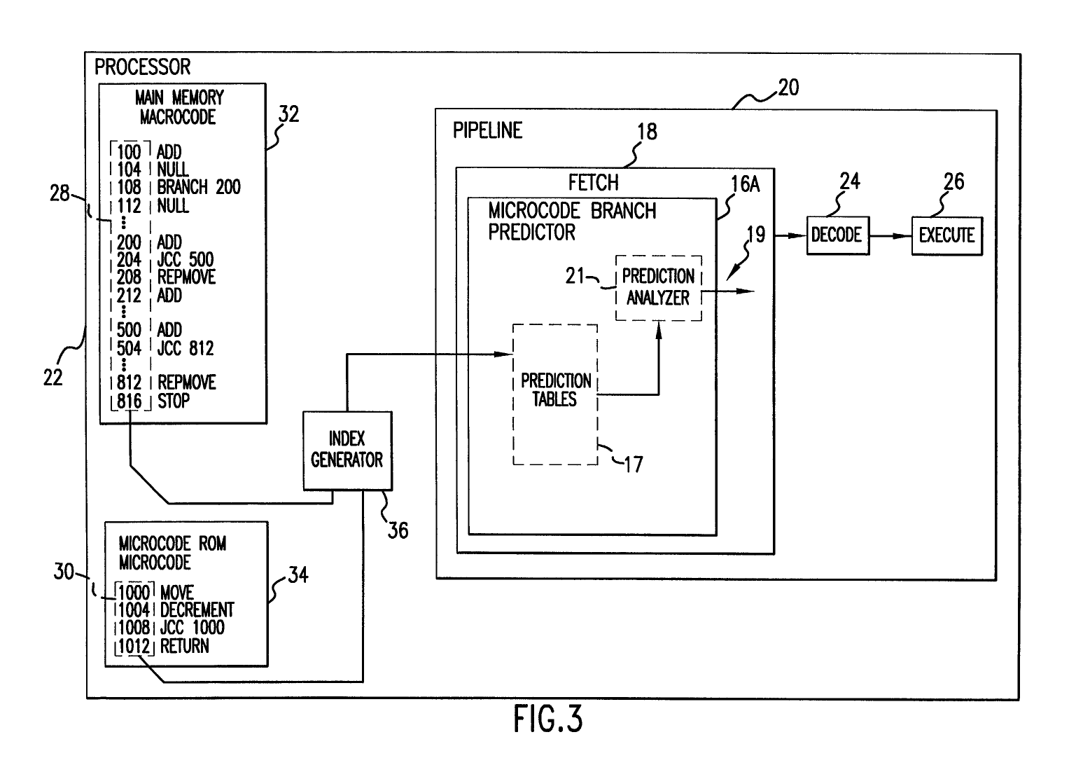

FIG. 3 is a block diagram of another embodiment of the invention, which is identical in most respects to the block diagram of FIG. 2. In FIG. 3, however, the index generator 36 is illustrated as performing its functionality outside of the microcode branch predictor 16A. A hashing function included in the functionality of the index generator 36 may hash the macrocode address 28 and microcode address 30 thus generating a unique value representative of the two addresses. The unique value may be applied to a microcode branch predictor 16A. Hashing function 36 may be any function, such as for example an XOR (exclusive or) function.

The above discussion may be more fully appreciated with reference to the discussion below.

### GENERAL PROGRAM FLOW

A program is a sequence of instructions that a processor executes. The program is stored in a memory. Each instruction in the program has associated with it an address of where it is located in the memory. For simplicity of explanation, let each instruction occupy four bytes of memory. An example of a program (written in pseudo-code, for purpose of illustration only) may be as follows:

100 ADD
104 NULL
108 BRANCH 200
112 NULL
.
.
.
200 ADD
204 JUMP CONDITIONAL CODE 500
208 REPMOVE
212 ADD
.
.
.
500 ADD
504 JCC 812
.
.
.
812 REPMOVE
816 STOP

Consider as an example a processor executing a program that includes several instructions, as shown above. The first instruction to execute is the ADD at address 100. As soon as the instruction at address 100 is executed the processor must fetch and execute the next instruction. The next instruction is at the next consecutive address, which is at address 104 (because in this example each instruction occupies four bytes of memory). The next instruction is at the next consecutive address, which is at address 108. The instruction at address 108 may be an unconditional branch instruction, which, for example, instructs the processor to branch to address 200. Therefore, instead of the processor fetching an instruction at the next consecutive address, which in this example would be address 112, the processor branches to address 200. If the instruction at address 200 is not a branch instruction then the processor will next fetch the next consecutive address, that is, address 204. For purposes of this example, let the instruction at address 200 be another ADD, which is not a branch instruction.

In addition to unconditional branches, as exemplified above, there are also conditional branches. A conditional branch yields a first result if the condition being evaluated is true and yields a second result if the condition is false. So, for example, at address 204 let the processor be instructed to perform the conditional branch instruction “JUMP CONDITIONAL CODE 500” (“JCC 500”). A JUMP CONDITIONAL CODE instruction instructs the processor to test the conditional code specified and, if the conditional code is true then jump to the target address, which in this example is address 500. If, however, the conditional code is false then the processor must fetch the next consecutive instruction, which in this example is at address 208. While in the example above the target address is forward (e.g., from address 204 to address 500), the target may also be backward (e.g., from address 204 to address 112).

### PIPELINING

In order to execute an instruction, a processor must accomplish several steps. First, an instruction is fetched from memory. In the example given above, the processor would go to memory address 100 and grab 4 bytes. Second, the instruction is decoded. In the example above, the instructions at address 100 would be decoded as an ADD. Third, the instruction must be executed. In the example of an ADD, the instruction would indicate what values to add and where to store the result. The example above is overly simplified and is used for purposes of illustration. An ADD in a contemporary processor (a typical processor in use today) may take fourteen different steps to complete.

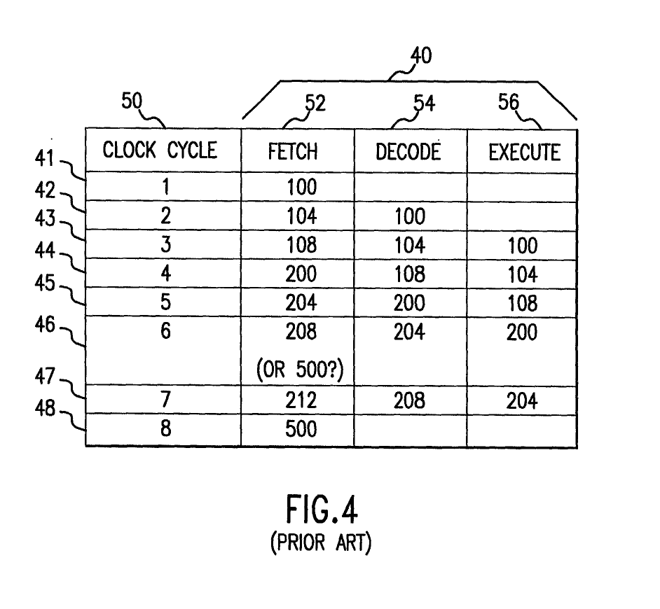

FIG. 4 illustrates the flow of instructions in the example program discussed above. FIG. 4 presents a simplified pipeline 40 having three stages: fetch 52, decode 54, and execute 56. Contemporary processors may have pipelines with forty stages, more or less. The simplified three-stage pipeline is presented for ease of explanation, and should not be considered as a limitation on the invention presented herein. The three stages 52, 54, 56 are illustrated as lying along the X-axis. An instruction is sequenced through the pipeline starting at the fetch 52 stage, then moving to the decode 54 stage, and finally to the execute 56 stage.

A processor works on clock cycles 50. An instruction may be advanced along the pipeline once per clock cycle. FIG. 4 illustrates the advancement of instructions for the example program presented above. Advancement in time is shown by travel down the Y-axis of FIG. 4. For purposes of illustration, let each step in the example program above require one clock cycle to complete. In the first clock cycle 41, the processor will fetch the instruction at address 100. In the second clock cycle 42, the processor will decode the instruction. Finally, in the third clock cycle 43, the processor will execute the ADD.

To increase the throughput of a processor, processors are designed to fetch the next instruction while the processor is decoding the present instruction (e.g., fetch 104 while decoding 100). This is what pipelining the execution means. So, for example, in the third clock cycle 43, when the processor is executing the ADD instruction of address 100, it will also be decoding the NULL instruction at address 104, as well as fetching the BRANCH instruction at address 108. Pipelining speeds up processing because, as shown in the example, without pipelining it would take three cycles to execute each instruction. With pipelining, an instruction is executed in every cycle.

### DETERMINING THE NEXT ADDRESS

At the beginning of a cycle, when an instruction is decoded a processor may not have made a determination as to the type of instruction being decoded. However, the processor must fetch a new instruction at a new address at the next clock cycle. It may be tacitly assumed that the next address to fetch is the next consecutive address, however, this assumption may be incorrect if the decoded instruction is a branch instruction. If the branch is taken, then the processor might have fetched the wrong address. Note, that as used herein, if the conditional code of a conditional branch is “true” and the processor is directed to the target address, then it is said that the branch is “taken.” If the conditional code of conditional branch is “false” and the processor is directed to the next sequential address, then it is said that the branch is not taken.

The process is illustrated in FIG. 4 for a conditional branch instruction (JCC at address 204). If, for example, at the fifth clock cycle 45 the processor is fetching JCC 500 from address 204, then at the sixth clock cycle 46 the processor is going to decode JCC 500, but what address should the processor fetch at the sixth clock cycle 46—address 208 or 500? The processor will not calculate the correct target address until the conditional code specified in the instruction at address 204 is executed. If the conditional code is true then the next address to fetch is address 500. If the conditional code is false, then the next address to fetch is address 208. At the sixth clock cycle 46, however, the processor cannot have calculated what the next address is to fetch. Contemporary processors, when executing conditional code, will attempt to predict which address should next be fetched. In the field of branch prediction, many algorithms are available to perform this prediction.

An alternative to predicting would be to wait until the conditional code has been executed. This, however, is an unacceptable alternative, because contemporary processors may have, for example, forty stage pipelines. Too many cycles, and therefore too much time, would be wasted if the processor waits for the conditional code to be executed. Because branches occur with great frequency in present day software, a processor cannot wait for conditional code to be executed.

Therefore, in a pipeline architecture, the processor will predict whether a particular branch will or will not be taken. Once the conditional code is executed, a test will be conducted to determine if the prediction was correct. If the prediction equals the result of the test, then processing may continue, otherwise the pipeline may have to be flushed.

Returning to the example above, at address 204 there is the instruction JCC 500. The processor fetches the instruction at the fifth clock cycle 45, decodes the instruction at the sixth clock cycle 46, and executes the instruction at the seventh clock cycle 47. For the sake of illustration, let it be stated that when the processor fetches the instruction it predicts that the branch will not be taken. Therefore, when the processor fetches address 204, the next address it will fetch will be address 208 (because the processor has predicted that the branch will not be taken). When the processor executes the JCC of address 204 at the seventh clock cycle 47 it will be decoding address 208 and fetching the next sequential address 212. During the execution of address 204, the processor will test to see if its prediction was correct, that is it will test to verify that the conditional code at address 204 was false. If the test proves that the prediction was correct, then the pipeline was properly filled. But, if the prediction was incorrect, then the pipeline must be flushed. So, for example, when the processor executes address 204 and the test determines that the JCC branch was taken, then the processor must flush the current decode and fetch (the two items that entered the pipeline after address 204) and must start a new fetch at the eighth clock cycle 48 with address 500.

### BRANCH PREDICTION

Predicting whether a branch is taken or not taken can be as simple as predicting that “all branches are not taken” or “all branches are taken.” Today's processors, however, use more complex branch predictors. A branch predictor is a structure that can predict whether a branch is taken or not taken. Typically, this structure, which is hereinafter referred to as a “conventional predictor,” is in the fetch stage of the processor's pipeline. All known conventional predictors are indexed to the single address of the instruction that includes the branch. Therefore, the minimum information that is provided to a conventional predictor is at least the single address of the instruction the processor is fetching.

In the example of “204 JCC 500,” the address 204 is communicated to the conventional predictor. Instructions are indexed by their addresses in conventional predictors in order to be able to give the conventional predictor that ability to provide different predictions for different branches. For example, if address 204 is a JCC and address 504 is also a JCC, then the predictions for these two branches (although they are both JCC) may be different. Using the example above, it can be seen that a conventional predictor is essentially taught or programmed that if the processor fetches address 204, then the processor will always go to either address 500 or address 208, depending on whether the branch is taken or not taken, respectively. The conventional predictor may make a prediction using an internal mathematical function, and the processor may verify the prediction in the execution stage of the pipeline, a few cycles later. By having the conventional predictor indexed to the single address of the fetched instruction, the conventional predictor is assured to recognize that there is a difference between the JCC at address 204 and the JCC at address 504.

### MICROCODE AND MACROCODE

The outcome of some instructions are very hard to execute. In order to execute these types of instructions, processors typically make use of microcode. For example, when an instruction is fetched and decoded, if it is an instruction whose outcome would be hard to execute, then the processor executes microcode, which is effectively a sub-program that performs the original instruction using a plurality of micro-instructions (instructions for microcode). Each of the micro-instructions may be simpler to execute than the original instruction. When the processor completes execution of the microcode sub-program, it will be as if it had executed the original instruction (which is hereinafter called macrocode). One may consider the microcode to be a subprogram, used to execute one instruction of macrocode. Typically, in a processor, at the decode stage, there will be a table (i.e., a ROM or a cache), where microcode sub-programs are stored.

As an example, consider the instruction named “REPMOVE,” which is an instruction used in x86 processors manufactured by Intel Corporation. REPMOVE is an acronym for repetitive move. The REPMOVE instruction essentially moves data stored in one location of memory to another location in memory. The size of memory to be moved is specified and is appended to the REPMOVE instruction (e.g., “REPMOVE source destination size,” where source is the source address of the data, destination is the destination address of the data, and size is the amount of data to be moved from the source to the destination).

It may not be desirable to perform a REPMOVE as one instruction. Therefore, to perform a REPMOVE, a microcode program is used to perform a plurality of relatively small moves. The microcode program may, for example, move one byte from the specified source to the specified destination and then loop until all of the bytes specified in the REPMOVE instruction have been moved. Therefore, when REPMOVE is encountered, a microcode sub-program performs a move and a branch until all of the bytes specified in the REPMOVE instruction have been moved.

The size of the block of data to be moved as a result of the REPMOVE instruction is specified, for example, in a register in the processor. By way of illustration, the processor might perform the following instructions in microcode in response to the macrocode instruction “REPMOVE source destination size:”

| | |
|---|---|
| 1000 MOVE source destination 1 | (move one byte from source to destination) |
| 1004 DECREMENT size | (decrement the size specified by REPMOVE) |
| 1008 JCC 1000 | (if size is different from zero; then jump to 1000; |
| | else sequential (i.e., terminate the subprogram). In |
| | practice, this JCC may be a JNZ, which is an |
| | instruction to Jump if Not Zero.) |
| 1012 RETURN | |

In the microcode above, the JCC at address 1008 will test the remaining size and if it is different than zero, it will jump back to the MOVE instruction at address 1000. If the remaining size is not different from zero then the JCC will “sequential,” which means the subprogram is terminated.

In the macrocode example used earlier, let us say that address 208 is a “REPMOVE” and that address 212 is an ADD. The processor fetches address 208 in the sixth clock cycle 46 (FIG. 4) and decodes address 208 in the seventh clock cycle 47. Also in the seventh clock cycle 47, the processor is going to fetch address 212, but the microcode is going to be generating quite a lot of instructions internally so the processor will typically stop the processing of the instruction at address 212 until all of the instructions for the microcode program are decoded and executed. Once all of the instructions for the microcode program are decoded and executed, the processor will resume processing the instruction at address 212 in the macrocode.

As illustrated above, macrocode instructions are specified by an address in memory such as address 100, 104, 108 and so on. Microcode instructions also have addresses such as 1000, 1004, 1008, etc. as illustrated above. The macrocode and microcode addresses, however, are in a totally different space. For this reason, they can overlap. For example, the microcode instruction MOVE could be at microcode address 100 as easily as it is at address 1000. Because the macrocode and microcode instructions are in a different space, the overlap of addresses is acceptable. The macrocode (i.e., main program) is stored in main memory, but microcode is stored and indexed to, for example, a microcode ROM, RAM, or other type of storage block.

A structure that can predict a microcode JCC in the same manner as the macrocode JCC will be referred to hereinafter as a microcode branch predictor. Note that nothing herein is meant to restrict the operation of a microcode branch predictor to JCC instructions. Without the microcode branch predictor, a processor must typically stop and wait for all microcode instructions to be executed before continuing to process macrocode.

Recall that in the example of a main program (i.e., macrocode) illustrated herein, both address 208 and address 812 are REPMOVE instructions. Also recall that the microcode sub-program for REPMOVE was:

1000 MOVE source destination 1
1004 DECREMENT size
1008 JCC 1000
1012 RETURN,

and that address 1008 was a microcode address—not a main program (or macrocode) address, Therefore, the JCC in microcode at address 1008 has two addresses that are associated with it—the microcode address 1008 and the macrocode address that called the REPMOVE micorcode sub-program (i.e., either 208 or 812).

In the example as described herein, the microcode JCC at microcode address 1008 will be associated with microcode address 1008, and will also be associated with a main program (macrocode) address. The main program address is variable. The main program address is the address of any macrocode that calls the REPMOVE microcode sub-program. Therefore, a micorcode branch predictor may be a structure that is indexed by at least two addresses—a microcode address and a macrocode address.

While the descriptions above has been provided in terms of conditional branch instructions, it will be understood that the same microcode branch predictor structure can be used for microcode indirect branches. An indirect branch is an unconditional branch. Therefore, it is always taken. The target address, however, in an indirect branch is not specified in the instruction; it is in a register—so it is variable (i.e., the target) can change. The target is therefore only known at execution. For indirect predictors, the target of the branch instruction is predicted. Such a predictor could be indexed by both macrocode addresses and microcode addresses. Nonetheless, as stated above, the microcode branch predictor structure can be used for microcode indirect branches, microcode conditional branches, and microcode unconditional branches.

The disclosed embodiments are illustrative of the various ways in which the present invention may be practiced. Other embodiments can be implemented by those skilled in the art without departing from the spirit and scope of the present invention.

What is claimed is:

1. A branch predictor, comprising:
a prediction analyzer; and
prediction tables indexed by at least a macrocode instruction address and a microcode instruction address.

2. The branch predictor of claim 1, further comprising an index generator having inputs for at least the macrocode instruction address and the microcode instruction address.

3. The branch predictor of claim 2, wherein the index generator performs a hashing function of at least the macrocode instruction address and the microcode instruction address.

4. The branch predictor of claim 1, further comprising a memory coupled to a fetch unit in which the branch predictor is located.

5. The branch predictor of claim 4, wherein when the branch predictor is predicting a macrocode branch instruction from the memory, signals for the microcode instruction address are zero.

6. A branch predictor, comprising:
a first input to accept a macrocode instruction address;
a second input to accept a microcode instruction address; and
a set of prediction tables to cross-reference the macrocode instruction address and the microcode instruction address to at least one microcode branch instruction result.

7. The branch predictor of claim 6, further comprising an index generator to generate an index value as a function of at least the macrocode instruction address and the microcode instruction address.

8. The branch predictor of claim 7, wherein the function is a hashing function.

9. The branch predictor of claim 8, wherein the hashing function is an XOR (exclusive or) function.

10. The branch predictor of claim 6, wherein the set of prediction tables are comprised of a history table which is indexed by a function of the microcode instruction address and the macrocode instruction address.

11. The branch predictor of claim 6, which processes only microcode branches.

12. The branch predictor of claim 6, wherein the microcode branch instruction is a conditional branch instruction.

13. The branch predictor of claim 6, wherein the microcode branch instruction is an indirect branch instruction.

14. The branch predictor of claim 6, further comprising a memory coupled to a fetch unit in which the branch predictor is located.

15. The branch predictor of claim 14, wherein when the branch predictor is predicting a macrocode branch instruction from the memory, signals for the microcode instruction address are zero.

16. A method of generating a value to index a branch predictor to differentiate branch predictions based on an address in a macrocode program including an instruction which calls an address in a microcode program, comprising:
establishing a first pointer to a microcode address having a first pointer value;
establishing a second pointer to a macrocode address having a second pointer value;
hashing at least the first pointer value and the second pointer value to yield a hashing function value; and
cross-referencing the hashing function value to a microcode branch result, wherein microcode branches are predicted based on the hashing function value.

17. The method of claim 16, wherein the microcode branch instruction is a conditional branch instruction.

18. The method of claim 16, wherein the microcode branch instruction is an indirect branch instruction.

19. A processor having a branch predictor structure to predict a branch instruction, the branch predictor indexed by:
a microcode address; and
a macrocode address.

20. The processor of claim 19, wherein the branch instruction is a conditional branch instruction.

21. The processor of claim 19, wherein the branch instruction is an indirect branch instruction.

22. The processor of claim 19, further comprising a memory coupled to a fetch unit in which the branch predictor is located.

23. The processor of claim 22, wherein when the branch predictor is predicting a macrocode branch instruction from the memory, signals for a microcode instruction address are zero.

24. A machine-readable medium having stored t hereon a plurality of executable instructions, the plurality of instructions comprising instructions to:
establish a first pointer to a microcode address having a first pointer value;
establish a second pointer to a macrocode address having a second pointer value;
hash at least the first pointer value and the second pointer value to yield a hashing function value; and
cross-reference the hashing function value to a microcode branch result, wherein microcode branches are predicted based on the hashing function value.

25. The machine readable material of claim 24, wherein an instruction at the microcode address is a conditional branch instruction.

26. The machine readable material of claim 24, wherein an instruction at the microcode address is an indirect branch instruction.
